(19) United States
(12) Patent Application Publication
(10) Pub. No.: US 2010/0086757 A1
(43) Pub. Date: Apr. 8, 2010

(54) Method for coating a component

(76) Inventors: Thomas Berndt, Berlin (DE); Francis-Jurjen Ladru, Berlin (DE); Marcus Mensing, Berlin (DE); Gerhard Reich, Berlin (DE); Falk Stadelmaier, Niederronhrdorf (CH)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/518,912

(22) PCT Filed: Sep. 21, 2007
(86) PCT No.: PCT/EP07/60045

§ 371 Date: Dec. 9, 2009

(30) Foreign Application Priority Data
Dec. 15, 2006 (EP) 06026084.1

(51) Int. Cl. B32B 7/00; B05D 1/10; B32B 18/00; B32B 5/22

(52) U.S. Cl. 428/216; 427/454; 428/325; 428/220

(57) ABSTRACT

A method is provided for coating a component with a multilayer ceramic coating in which the individual layers of the ceramic coating are applied covering one another on the component, and in which ceramic particles are supplied to a coating burner, melted partly or completely by the coating burner, and deposited on the component. The ceramic particles have a particle size, which increases from layer to layer, and are supplied to the coating burner. Furthermore, a multilayer ceramic coating and a component which has with a multilayer ceramic coating are provided.

### CROSS REFERENCE TO RELATED APPLICATIONS

This application is the US National Stage of International Application No. PCT/EP2007/060045, filed Sep. 21, 2007 and claims the benefit thereof. The International Application claims the benefits of European Patent Office application No. 06026084.1 EP filed Dec. 15, 2006, both of the applications are incorporated by reference herein in their entirety.

### FIELD OF INVENTION

The invention relates to a method for coating component with a multilayer ceramic coating, in which individual layers of the ceramic coating are applied above and covering one another on the component by ceramic particles being delivered to a coating burner, fully or partially melted by it and deposited on the component. The invention furthermore relates to a multilayer ceramic coating and to a component, which is provided with a multilayer ceramic coating.

### BACKGROUND OF INVENTION

Components which are used in an aggressive atmosphere in a temperature range in excess of 800° C. are often provided with protective coatings in order to extend their lifetime. For example, gas turbine rotor blades or guide vanes are provided with thermal barrier coatings containing ceramic, or complex coating systems are applied which protect the blades against thermal, chemical and mechanical stresses.

The thermal barrier coatings containing ceramic may, for example, contain zirconium oxides which are stabilized by yttrium oxides. Inter alia, plasma spraying is used as a method for applying them. In this case, powdered ceramic particles are delivered to a plasma coating burner in which they are fully or partially melted, and subsequently deposited on the component. The ceramic particles then form the thermal barrier coating on the surface of the component.

In many cases, the thermal barrier coating is formed in individual layers applied above and covering one another on the component, i.e. for a standard coating thickness of 200-400 μm, 4-15 layers with a layer thickness of 20-50 μm are applied above one another.

A method for forming multilayer thermal barrier coatings on the surface of turbine blades is described in DE 100 22 157 C1. Here, powdered ceramic particles are delivered to the coating burner, fully or partially melted there and subsequently deposited in the form of individual layers on the surface of the turbine blade. Ceramic particles with a differently large grain sizes are used, the ceramic particles being melted to a different degree as a function of their size by suitable control of the burner power, i.e. the smaller ceramic particles melt fully and the larger ceramic particles are only melted superficially. In this way, the porosity of the individual layers of the thermal barrier coating can be varied.

The ceramic coatings described in the prior art have a total thickness which is not more than 450 μm. This is due inter alia to the fact that various problems occur when producing ceramic thermal barrier coatings with a larger thickness.

### SUMMARY OF INVENTION

When the thermal barrier coating is formed by applying individual layers lying above one another, the layers already present on the component surface insulate to an increasing extent during the application process so that the newly applied coating material cannot dissipate heat to the other layers. Heat stagnation occurs and the temperature of the newly applied layers consequently increases, the effect of which is that they are compacted more strongly. Owing to this compaction, however, the porosity of the individual layers decreases, which on the one hand reduces their thermal insulation capacity during operation of the component and, on the other hand, leads to substantially inferior adhesion of the layers to one another. This may inter alia cause coating failure to occur, i.e. there is a risk that regions of the thermal barrier coating will be locally detached.

It is therefore an object of the present invention to refine a method of the type mentioned in the introduction, so that multilayer ceramic coatings with a thickness of more than 450 μm can be applied on a component. The component should be coated with the individual layers in such a way that they keep a sufficient porosity, so as to ensure both a high thermal insulation capacity and a good adhesion capacity of the layers to one another.

This object is achieved according to the invention in that ceramic particles with an increasingly large grain size are delivered to the coating burner from layer to layer.

The basic concept of the invention is thus to increase the grain size of the ceramic particles from layer to layer. Initially, the component is coated with a first layer by delivering ceramic particles with the smallest grain size used overall, for example −53 μm+11 μm, to the coating burner. In order then to apply a second layer on the first layer, ceramic particles with a grain size which is larger than that of the ceramic particles for the first layer are delivered to the coating burner. Subsequently, the further layers are applied in a similar way with a constant increase in the grain size of the ceramic particles being used.

The advantage of this is that increasing the grain size of the ceramic particles from layer to layer counteracts the effect of compaction of the individual layers with an increasing coating thickness, due to the heat stagnation which occurs. The individual layers are thus formed with a virtually constant porosity, which on the one hand preserves their thermal insulation capacity and, on the other hand, ensures adhesion of the individual layers to one another. This precludes the risk of coating failure.

According to a first embodiment of the invention, the power of the coating burner is adapted continuously to the grain size of the ceramic particles when applying the individual layers of the ceramic coating. In this way, it is possible to control or modify the porosity of the individual layers even more accurately during the coating process. Adapting the burner power can, in particular, influence the degree to which the ceramic particles are melted.

It is also possible to use a plasma burner as the coating burner. In this case, the power of the plasma burner may, for example, be adapted by varying the current strength and/or the hydrogen gas flow rate and/or the argon gas flow rate. For instance, a current strength of 500-600 A, a hydrogen gas flow rate of 12-16 NLPM and an argon gas flow rate of 40-60 NLPM may be set. Gas mixtures of argon, nitrogen and hydrogen may optionally also be used, in which case Ar/N₂/H₂ mixing ratios of 30-40/10-20/8-14 may in particular be employed.

The individual layers of the ceramic coating may be applied with a thickness in the range of between 10 and 100 μm, a thickness of between 20-50 μm being suitable in particular. In this way, a ceramic coating will be obtained which has a high thermal insulation capacity and is mechanically stable.

In another embodiment of the invention, the multilayer ceramic coating may be applied with a total thickness in the range of between 100-1000 μm, in particular between 200 and 700 μm, and particularly preferably between 250 and 600 μm.

For example, ceramic particles with a grain size of −75 μm+10 μm or −53 μm+11 μm or −90 μm+11 μm may be delivered to the coating burner for the first layer.

For application of the last layer, i.e. the outermost layer of the multilayer ceramic coating, ceramic particles with a grain size of −106 μm+11 μm or −125 μm+45 μm or −150 μm+75 μm may be delivered to the coating burner.

Furthermore, a mixture of ceramic particles with at least two different grain sizes may also be delivered to the coating burner. By suitable mixing of the two ceramic particle fractions with different grain sizes, the overall grain size of the ceramic particles delivered to the coating burner can be varied in a straightforward way.

It is also possible to apply a multilayer bottom coat on the component before the coating, by ceramic particles with a constant grain size being delivered to a coating burner, fully or partially melted by it and applied on the component in individual layers. The multilayer ceramic coating is subsequently formed on the bottom coat.

Ceramic particles with a constant grain size of −75 μm+10 μm or −53 μm+11 μm or −90 μm+11 μm may be delivered to the coating burner in order to form the bottom coat. Furthermore, the individual layers of the bottom coat may be applied with a thickness in the range of between 10-100 μm, in particular between 20-50 μm. The total thickness of the bottom coat may lie in the range of between 150 and 450 μm.

It is also possible for a multilayer top coat to be applied on the multilayer ceramic coating by ceramic particles being delivered to a coating burner, fully or partially melted by it and applied on the multilayer ceramic coating in individual layers above and covering one another. The ceramic particles for the top coat will have a larger grain size than the ceramic particles which are delivered to the coating burner when applying the last layer of the multilayer ceramic coating.

The object of the invention is also achieved by a multilayer ceramic coating having the features of the claims and by a component having the features of the claims.

### BRIEF DESCRIPTION OF THE DRAWINGS

The invention will be explained in more detail below with the aid of an exemplary embodiment with reference to the drawing. In the drawing:

FIG. 1 shows a schematic partial sectional view of a turbine blade with a multilayer ceramic coating according to the invention, and

FIG. 2 shows a schematic representation of a device for coating a component,

FIG. 3 shows a gas turbine,

FIG. 4 shows a perspective view of a turbine blade, and

FIG. 5 shows a combustion chamber.

### DETAILED DESCRIPTION OF INVENTION

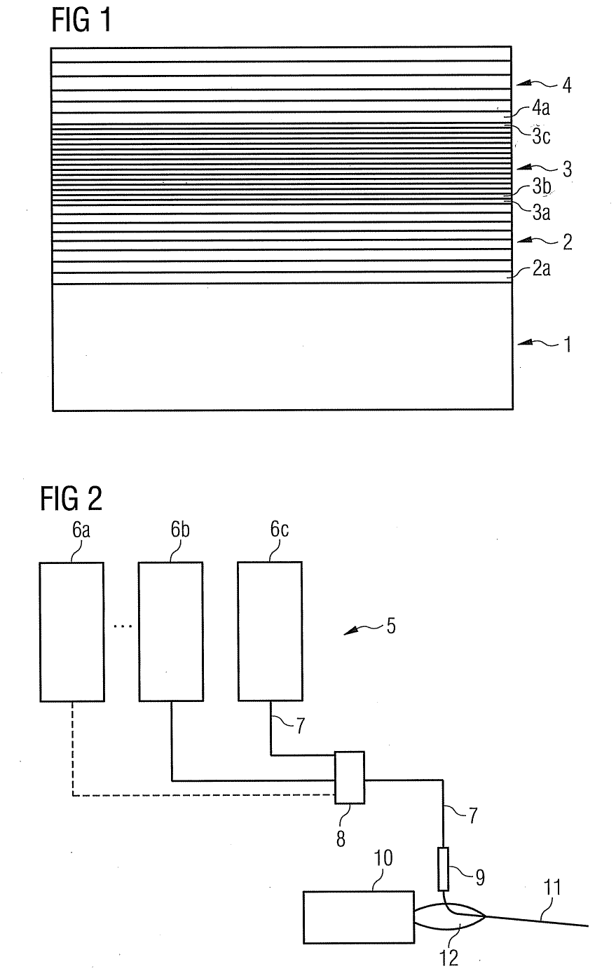

FIG. 1 shows a schematic partial sectional view of a turbine blade 1, which is coated on its surface with a multilayer ceramic coating 3 according to the invention. A multilayer bottom coat 2 is formed below the multilayer ceramic coating 3 on the turbine blade 1, and there is a multilayer top coat 4 on the multilayer ceramic coating 2. The bottom coat 2, the multilayer ceramic coating 3 and the top coat 4 are respectively formed by layers 2a, 3a-c, 4a arranged above and covering one another.

The bottom coat 2 is applied directly on the turbine blade 1. The layers 2a of the bottom coat consist of ceramic particles with a constant grain size partially fused together; the grain size may be −75 μm+10 μm or −53 μm+11 μm or −90 μm+11 μm. The layers 2a of the bottom coat have a thickness in the range of between 10-100 μm, in particular between 20-50 μm. The total thickness of the bottom coat 2 lies between 150 and 450 μm.

The multilayer ceramic coating 3 is applied over the surface of the bottom coat 2. The individual layers 3a, 3b, 3c of the multilayer ceramic coating 3 consist of ceramic particles partially fused together, the ceramic particles increasingly having a larger grain size from layer to layer. This means that the ceramic particles, partially fused together, of the first layer 3a have a smaller grain size than the ceramic particles, partially fused together, of the second layer 3. The two layers 3a, 3b, however, have an approximately equal porosity so that they both have a high thermal insulation capacity and strong adhesion of the layers 3a, 3b to one another is ensured.

The layers 3a, 3b, 3c have a thickness in the range of between 10-100 μm, in particular between 20 and 50 μm. The total thickness of the multilayer ceramic coating 3 lies in the range of between 100-1000 μm, in particular between 200 and 700 μm, and particularly preferably between 250 and 650 μm.

The multilayer top coat 4 is applied over the surface of the multilayer ceramic coating 3. The top coat 4 is formed by the layers 4a arranged above one another, which consist of ceramic particles partially fused together. The grain size of these ceramic particles is larger than the grain size of the ceramic particles of the last layer 3c of the multilayer ceramic coating 3.

The multilayer ceramic coating 3 has on the one hand a high thermal insulation capacity and, on the other hand, possesses great mechanical stability so that the risk of coating failure is reduced.

In order to coat the turbine blade 1, in a first step the bottom coat 2 is applied layer by layer on the surface of the turbine blade 1. To this end, ceramic particles with a constant grain size are delivered to a coating burner, fully or partially melted by it and then deposited on the turbine blade in the individual layers 2a above and covering one another.

In a second step, the multilayer ceramic coating 3 is then applied on the bottom coat 2. To this end, ceramic particles are delivered to a coating burner, and these are fully or partially melted by it and then deposited in the form of the layers 3a, 3b, 3c.

For example, ceramic particles with a first grain size of −75 μm+10 may be introduced into the coating burner for the first layer of the multilayer ceramic coating 3.

The first layer 3a is applied on the surface of the bottom coat 2, and the second layer 3b is applied on and directly covering the first layer 3a. Ceramic particles with an increasingly large grain size from layer to layer are delivered to the coating burner. This means that the ceramic particles which are delivered to the coating burner in order to form the layer 3b have a larger grain size than the ceramic particles which are delivered to the coating burner in order to form the layer 3a. The ceramic particles with the largest grain size used for the multilayer ceramic coating 3 are finally melted fully or partially by the coating burner when the last layer 3c is being deposited.

The grain sizes of the ceramic particles may, for example, be varied by delivering ceramic particles with at least two different grain sizes simultaneously to the coating burner. A respectively increasing overall grain size may then be obtained by suitable mixing of the two grain sizes.

Furthermore, the power of the coating burner may be adapted continuously to the grain size of the ceramic particles. Thus, the power may be increased when increasingly large ceramic particles are intended to be deposited. This ensures that even the larger ceramic particles are melted sufficiently in order to be bound firmly into the layers 3a, 3b, 3c.

If a plasma burner is used as the coating burner, its power may be adapted by varying the current strength and/or the hydrogen gas flow rate and/or the argon gas flow rate.

In a final step, the top coat 4 is deposited on the multilayer ceramic coating 3 so as to cover its surface. To this end, ceramic particles with a constant grain size are fully or partially melted in the coating burner and deposited in the individual layers 4a above and covering one another on the multilayer ceramic coating 3.

For the layers 4a, ceramic particles are used which have a larger grain size than the ceramic particles that were used for the last layer 3c of the multilayer ceramic coating 3. This ensures that a sufficient porosity is also imparted to the layers 4a of the top coat 4, so that they have both a high thermal insulation capacity and good adhesion to one another.

FIG. 2 schematically shows a device 5 for coating a component, for example the turbine blade 1. The device 5 comprises three feed units 6a-c, which respectively contain ceramic particles with a differently large grain size. The feed units 6a-c are respectively connected via lines 7 to a powder valve 8, and are configured to deliver ceramic particles to the powder valve 8. The powder valve 8 is designed so that it mixes the ceramic particles delivered to it, in order to form a coating powder with a uniform grain size. The resulting grain size of the coating powder depends on the quantities and the grain sizes of the ceramic particles respectively delivered by the feed units 6a-c.

The powder valve 8 is connected via a line 7 to a powder injector 9. The powder injector 9 is arranged relative to a plasma burner 10 so that it can send a flow of coating powder 11 into the flame 12 of the plasma burner 10.

The device 5 may additionally comprise a control unit, which controls the delivery of the ceramic particles from the feed units 6a-c, as well as the functions of the powder valve 8 and the powder injector 9. The controller may also be configured to regulate the power of the plasma burner as a function of the grain size of the coating powder, i.e. to increase its power for a larger grain size in order to ensure sufficient melting of the ceramic particles. Besides the three feed units 6a-c shown, further feed units may also be provided.

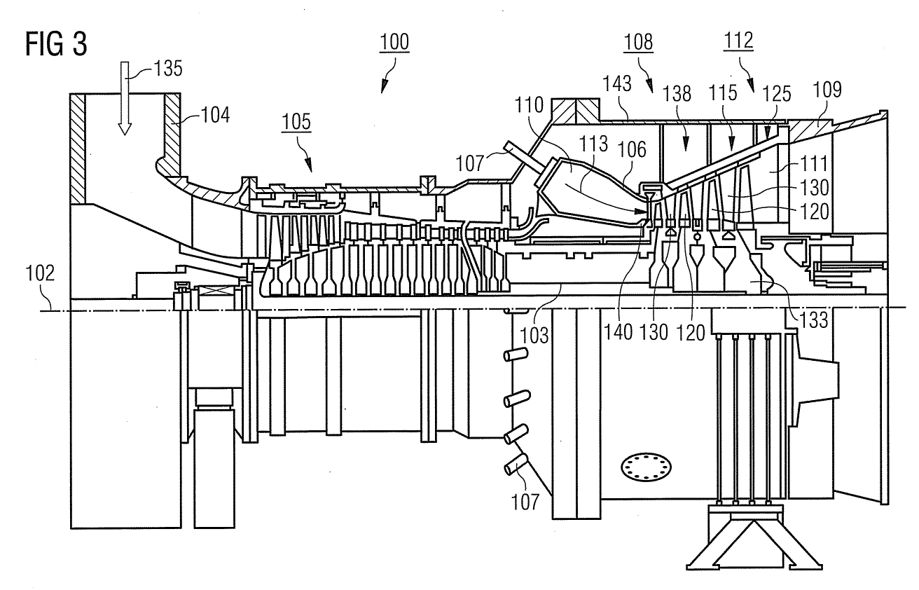

FIG. 3 shows a gas turbine 100 by way of example in a partial longitudinal section.

The gas turbine 100 internally comprises a rotor 103, which will also be referred to as the turbine rotor, mounted so as to rotate about a rotation axis 102 and having a shaft 101.

Successively along the rotor 103, there are an intake manifold 104, a compressor 105, an e.g. toroidal combustion chamber 110, in particular a ring combustion chamber, having a plurality of burners 107 arranged coaxially, a turbine 108 and the exhaust manifold 109.

The ring combustion chamber 110 communicates with an e.g. annular hot gas channel 111. There, for example, four successively connected turbine stages 112 form the turbine 108. Each turbine stage 112 is formed for example by two blade rings. As seen in the flow direction of a working medium 113, a guide vane row 115 is followed in the hot gas channel 111 by a row 125 formed by rotor blades 120.

The guide vanes 130 are fastened on an inner housing 138 of a stator 143 while the rotor blades 120 of a row 125 are fastened on the rotor 103, for example by means of a turbine disk 133. Coupled to the rotor 103, there is a generator or a work engine (not shown).

During operation of the gas turbine 100, air 135 is taken in and compressed by the compressor 105 through the intake manifold 104. The compressed air provided at the turbine-side end of the compressor 105 is delivered to the burners 107 and mixed there with a fuel. The mixture is then burnt to form the working medium 113 in the combustion chamber 110. From there, the working medium 113 flows along the hot gas channel 111 past the guide vanes 130 and the rotor blades 120. At the rotor blades 120, the working medium 113 expands by imparting momentum, so that the rotor blades 120 drive the rotor 103 and the work engine coupled to it.

The components exposed to the hot working medium 113 become heated during operation of the gas turbine 100. Apart from the heat shield elements lining the ring combustion chamber 110, the guide vanes 130 and rotor blades 120 of the first turbine stage 112, as seen in the flow direction of the working medium 113, are heated the most.

In order to withstand the temperatures prevailing there, they may be cooled by means of a coolant. Substrates of the components may also comprise a directional structure, i.e. they comprise a single crystal (SX structure) or only longitudinally directed grains (DS structure). Iron-, nickel- or cobalt-based superalloys are for example used as material for the components, in particular for the turbine blades 120, 130 and components of the combustion chamber 110. Such superalloys are known for example from EP 1 204 776 B1, EP 1 306 454, EP 1 319 729 A1, WO 99/67435 or WO 00/44949; with respect to the chemical composition of the alloy, these documents are part of the disclosure.

The guide vanes 130 comprise a guide vane root (not shown here) facing the inner housing 138 of the turbine 108, and a guide vane head lying opposite the guide vane root. The guide vane head faces the rotor 103 and is fixed on a fastening ring 140 of the stator 143.

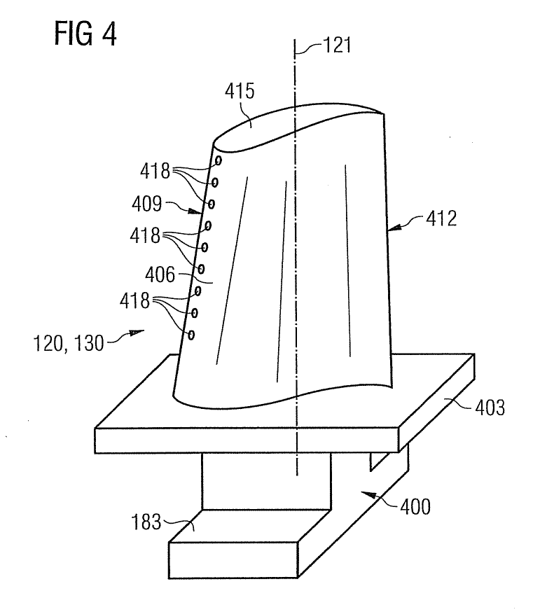

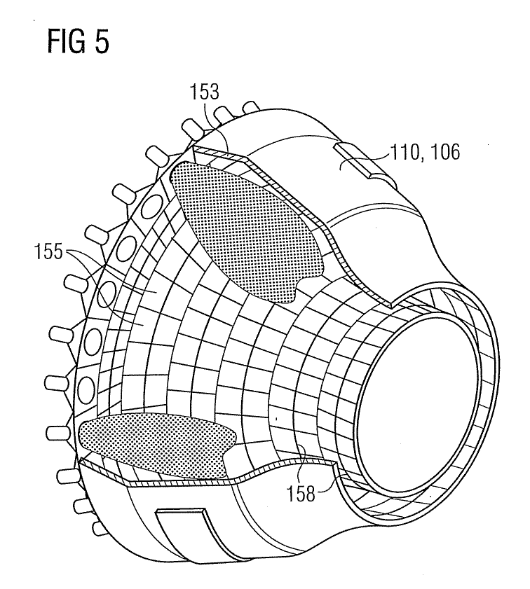

FIG. 4 shows a perspective view of a rotor blade 120 or guide vane 130 of a turbomachine, which extends along a longitudinal axis 121.

The turbomachine may be a gas turbine of an aircraft or of a power plant for electricity generation, a steam turbine or a compressor.

The blade 120, 130 comprises, successively along the longitudinal axis 121, a fastening zone 400, a blade platform 403 adjacent thereto as well as a blade surface 406 and a blade tip 415. As a guide vane 130, the vane 130 may have a further platform (not shown) at its vane tip 415.

A blade root 183 which is used to fasten the rotor blades 120, 130 on a shaft or a disk (not shown) is fowled in the fastening zone 400. The blade root 183 is configured, for example, as a hammerhead. Other configurations as a firtree or dovetail root are possible.

The blade 120, 130 comprises a leading edge 409 and a trailing edge 412 for a medium which flows past the blade surface 406. In conventional blades 120, 130, for example solid metallic materials, in particular superalloys, are used in all regions 400, 403, 406 of the blade 120, 130. Such superalloys are known for example from EP 1 204 776 B1, EP 1 306 454, EP 1 319 729 A1, WO 99/67435 or WO 00/44949; with respect to the chemical composition of the alloy, these documents are part of the disclosure.

The blade 120, 130 may in this case be manufactured by a casting method, also by means of directional solidification, by a forging method, by a machining method or combinations thereof.

Workpieces with a single-crystal structure or single-crystal structures are used as components for machines which are exposed to heavy mechanical, thermal and/or chemical loads during operation. Such single-crystal workpieces are manufactured, for example, by directional solidification from the melts. These are casting methods in which the liquid metal alloy is solidified to form a single-crystal structure, i.e. to faun the single-crystal workpiece, or is directionally solidified. Dendritic crystals are in this case aligned along the heat flux and form either a rod crystalline grain structure (columnar, i.e. grains which extend over the entire length of the workpiece and in this case, according to general terminology usage, are referred to as directionally solidified) or a single-crystal structure, i.e. the entire workpiece consists of a single crystal. It is necessary to avoid the transition to globulitic (polycrystalline) solidification in these methods, since nondirectional growth will necessarily form transverse and longitudinal grain boundaries which negate the beneficial properties of the directionally solidified or single-crystal component. When directionally solidified structures are referred to in general, this is intended to mean both single crystals which have no grain boundaries or at most small-angle grain boundaries, and also rod crystal structures which, although they do have grain boundaries extending in the longitudinal direction, do not have any transverse grain boundaries. These latter crystalline structures are also referred to as directionally solidified structures. Such methods are known from U.S. Pat. No. 6,024,792 and EP 0 892 090 A1; with respect to the solidification method, these documents are part of the disclosure.

The blades 120, 130 may also have coatings against corrosion or oxidation, for example MCrAlX (M is at least one element from the group iron (Fe), cobalt (Co), nickel (Ni), X is an active element and stands for yttrium (Y) and/or silicon and/or at least one rare earth element, or hafnium (Hf)). Such alloys are known from EP 0 486 489 B1, EP 0 786 017 B1, EP 0 412 397 B1 or EP 1 306 454 A1, which, with respect to the chemical composition of the alloy, are intended to be part of this disclosure.

The density is preferably 95% of the theoretical density.

A protective aluminum oxide layer (TGO=thermally grown oxide layer) is formed on the MCrAlX coating (as an interlayer or as the outermost coat).

The coating composition preferably comprises Co-30Ni-28Cr-8Al-0.6Y-0.7Si or Co-28Ni-24Cr-10Al-0.6Y. Besides these cobalt-based protective coatings, it is also preferable to use nickel-based protective coatings such as Ni-10Cr-12Al-0.6Y-3Re or Ni-12Co-21Cr-11Al-0.4Y-2Re or Ni-25Co-17Cr-10Al-0.4Y-1.5Re.

On the MCrAlX, there may furthermore be a thermal barrier coating, which is preferably the outermost coat and consists for example of ZrO₂, Y₂O₃—ZrO₂, i.e. it is not stabilized or is partially or fully stabilized by yttrium oxide and/or calcium oxide and/or magnesium oxide. The thermal barrier coating covers the entire MCrAlX coating.

Rod-shaped grains are produced in the thermal barrier coating by suitable coating methods, for example electron beam deposition (EB-PVD).

Other coating methods may be envisaged, for example atmospheric plasma spraying (APS), LPPS, VPS or CVD. The thermal barrier coating may comprise produces porous, micro- or macro-cracked grains for better thermal shock resistance. The thermal barrier coating is thus preferably more porous than the MCrAlX coating.

The blade 120, 130 may be designed to be a hollow or solid. If the blade 120, 130 is intended to be cooled, it will be hollow and optionally also comprise film cooling holes 418 (indicated by dashes).

FIG. 5 shows a combustion chamber 110 of a gas turbine 100. The combustion chamber 110 is designed for example as a so-called ring combustion chamber in which a multiplicity of burners 107, which produce flames 156 and are arranged in the circumferential direction around a rotation axis 102, open into a common combustion chamber space 154. To this end, the combustion chamber 110 as a whole is designed as an annular structure which is positioned around the rotation axis 102.

In order to achieve a comparatively high efficiency, the combustion chamber 110 is designed for a relatively high temperature of the working medium M, i.e. about 1000° C. to 1600° C. In order to permit a comparatively long operating time even under these operating parameters which are unfavorable for the materials, the combustion chamber wall 153 is provided with an inner lining formed by heat shield elements 155 on its side facing the working medium M.

Owing to the high temperatures inside the combustion chamber 110, a cooling system may also be provided for the heat shield elements 155 or for their retaining elements. The heat shield elements 155 are then hollow, for example, and optionally also have film cooling holes (not shown) opening into the combustion chamber space 154.

Each heat shield element 155 made of an alloy is equipped with a particularly heat-resistant protective coating (MCrAlX coating and/or ceramic coating) on the working medium side, or is made of refractory material (solid ceramic blocks).

These protective coatings may be similar to the turbine blades, i.e. for example MCrAlX means: M is at least one element from the group iron (Fe), cobalt (Co), nickel (Ni), X is an active element and stands for yttrium (Y) and/or silicon and/or at least one rare earth element, or hafnium (Hf). Such alloys are known from EP 0 486 489 B1, EP 0 786 017 B1, EP 0 412 397 B1 or EP 1 306 454 A1, which, with respect to the chemical composition of the alloy, are intended to be part of this disclosure.

On the MCrAlX, there may furthermore be an e.g. ceramic thermal barrier coating which consists for example of ZrO₂, Y₂O₃—ZrO₂, i.e. it is not stabilized or is partially or fully stabilized by yttrium oxide and/or calcium oxide and/or magnesium oxide.

Rod-shaped grains are produced in the thermal barrier coating by suitable coating methods, for example electron beam deposition (EB-PVD).

Other coating methods may be envisaged, for example atmospheric plasma spraying (APS), LPPS, VPS or CVD. The thermal barrier coating may comprise porous, micro- or macro-cracked grains for better thermal shock resistance.

Refurbishment means that turbine blades 120, 130 or heat shield elements 155 may need to be stripped of protective coatings (for example by sandblasting) after their use. The corrosion and/or oxidation layers or products are then removed. Optionally, cracks in the turbine blade 120, 130 or heat shield element 155 are also repaired. The turbine blades 120, 130 or heat shield elements 155 are then recoated and the turbine blades 120, 130 or heat shield elements 155 are used again.

1.-24. (canceled)

25. A method for coating a component with a multilayer ceramic coating, comprising:
applying a first plurality of individual layers of a multilayer ceramic coating one above another on the component, each individual layer is applied by:
delivering a plurality of ceramic particles to a coating burner,
melting fully or partially the plurality of ceramic particles, and
depositing the plurality of ceramic particles on the component; and
applying a second plurality of individual layers of a multilayer top coat on the multilayer ceramic coating, each individual layer is applied by:
delivering a plurality of ceramic particles to the coating burner,
melting fully or partially the plurality of ceramic particles, and
depositing the plurality of ceramic particles on the multilayer ceramic coating,
wherein the plurality of ceramic particles with an increasingly larger grain size are delivered to the coating burner for each subsequent layer of the multilayer ceramic coating, with a first layer of the multilayer ceramic coating having the smallest grain size and laying closest to the component and a last layer of the multilayer ceramic coating having the largest grain size and laying furthest from the component, and
wherein the second plurality of individual layers are applied above and covering one another for the multilayer top coat, the plurality of ceramic particles for each individual layer having a larger grain size than the plurality of ceramic particles which are delivered to the coating burner when applying the last layer of the multilayer ceramic coating.

26. The method as claimed in claim 25, wherein a first power of the coating burner is continuously adapted to the grain size of the plurality of ceramic particles when applying the first plurality of individual layers.

27. The method as claimed in claim 26, wherein a plasma burner is used as the coating burner.

28. The method as claimed in claim 27, wherein a second power of the plasma burner is adapted by varying a current strength and/or a hydrogen gas flow rate and/or an argon gas flow rate.

29. The method as claimed in claim 25, wherein each individual layer of the first plurality of individual layers is applied with a thickness in a range of between 10 and 100 μm.

30. The method as claimed in claim 25, wherein the multilayer ceramic coating is applied with a total thickness in the range of between 100 and 1000 μm.

31. The method as claimed in claim 25, wherein the plurality of ceramic particles with a grain size of −75 μm+10 μm or −53 μm+11 μm or −90 μm+11 μm are delivered to the coating burner for the first layer.

32. The method as claimed in claim 25, wherein the plurality of ceramic particles with a grain size of −106 μm+11 μm or −125 μm+45 μm or −150 μm+75 μm are delivered to the coating burner for the last layer.

33. The method as claimed in claim 25, wherein a mixture of the plurality of ceramic particles having at least two different grain sizes is delivered to the coating burner.

34. The method as claimed in claim 25,
wherein a multilayer bottom coat is applied on the component before the multilayer ceramic coating, and
wherein a plurality of ceramic particles with a constant grain size is delivered to a coating burner, fully or partially melted in the coating burner, and applied on the component in a third plurality of individual layers.

35. The method as claimed in claim 34, wherein the plurality of ceramic particles with the constant grain size of −75 μm+10 μm or −53 μm+11 μm or −90 μm+11 μm are delivered to the coating burner in order to form the multilayer bottom coat.

36. The method as claimed in claim 34, wherein the third plurality of individual layers of the multilayer bottom coat are applied with each individual layer having the thickness in the range of between 10 and 100 μm.

37. The method as claimed in claim 34, wherein the multilayer bottom coat is applied with a total thickness in the range of between 150 and 450 μm.

38. A multilayer ceramic coating, comprising:
a first plurality of individual layers, arranged above and covering one another,
wherein the first plurality of individual layers consists of a plurality of ceramic particles partially fused together,
wherein each subsequent layer of the first plurality of individual layers, starting from a first layer which lays closest to the component, has a plurality of ceramic particles having a larger grain size than the grain size of the plurality of ceramic particles of a previous layer,
wherein a multilayer top coat comprising a second plurality of individual layers arranged above and covering one another is applied on the multilayer ceramic coating, and
wherein each individual layer of the second plurality of individual layers consists of a plurality of ceramic particles partially fused together having a grain size that is larger than the grain size of the plurality of ceramic particles of a last layer of the multilayer ceramic coating.

39. The multilayer ceramic coating as claimed in claim 38, wherein each individual layer of the first plurality of individual layers has a thickness in a range of between 10 and 100 μm.

40. The multilayer ceramic coating as claimed in claim 38, wherein a total thickness of the multilayer ceramic coating lies in the range of between 100 and 1000 μm.

41. The multilayer ceramic coating as claimed in claim 38, wherein the plurality of ceramic particles of the first layer have the grain size of −75 μm+10 μm or −53 μm+11 μm or −90 μm+11 μm.

42. The multilayer ceramic coating as claimed in claim 38, wherein the plurality of ceramic particles of the last layer have the grain size of −106 μm+11 μm or −125 μm+45 μm or −150 μm+75 μm.

43. The multilayer ceramic coating as claimed in claim 38, wherein the plurality of ceramic particles have at least two different grain sizes.

44. A component, comprising:
a multilayer ceramic coating, comprising a first plurality of individual layers, arranged above and covering one another,
wherein the first plurality of individual layers consists of a plurality of ceramic particles partially fused together,
wherein each subsequent layer of the first plurality of individual layers, starting from a first layer which lays closest to the component, has a plurality of ceramic particles having a larger grain size than the grain size of the plurality of ceramic particles of a previous layer,
wherein a multilayer top coat comprising a second plurality of individual layers arranged above and covering one another is applied on the multilayer ceramic coating, and
wherein the second plurality of individual layers consists of a plurality of ceramic particles partially fused together having a grain size that is larger than the grain size of the plurality of ceramic particles of a last layer of the multilayer ceramic coating.
